(19) United States
(12) Patent Application Publication
(10) Pub. No.: US 2026/0067440 A1
(43) Pub. Date: Mar. 5, 2026

(54) CONTROL APPARATUS, CONTROL METHOD, AND STORAGE MEDIUM

(71) Applicant: CANON KABUSHIKI KAISHA, Tokyo (JP)

(72) Inventor: Shohei IWAMOTO, Kanagawa (JP)

(21) Appl. No.: 19/313,295

(22) Filed: Aug. 28, 2025

(30) Foreign Application Priority Data
Sep. 3, 2024 (JP) 2024-151820

(51) Int. Cl. H04N 13/279; H04N 13/282; H04N 13/296

(52) U.S. Cl. CPC H04N 13/279; H04N 13/282; H04N 13/296

(57) ABSTRACT

The present disclosure aims to realize a feeling of camera shake pleasant to a viewer in a virtual viewpoint image. Operation information designating a virtual camera in a virtual space via an operation member of an input device and angular velocity information from a gyro sensor included in the input device are obtained for each frame. An orientation of the virtual camera is determined for each frame based on the obtained operation information. Further, the orientation of the virtual camera determined for each frame is corrected based on the angular velocity information corresponding to a plurality of frames.

### BACKGROUND

### Field of the Technology

The present disclosure relates to a control technique for a virtual camera in a virtual space.

### Description of the Related Art

There is a technique of arranging a plurality of imaging apparatuses in different positions, performing synchronous image capturing, and using a plurality of captured images obtained through the image capturing to generate an image (virtual viewpoint image) indicating a view from a virtual camera (virtual viewpoint) which is not actually present in a three-dimensional space as a target of image capturing. In the generation, a user operates, for example, a controller with a joystick to set a position or orientation of a new virtual camera while seeing the generated virtual viewpoint image in a UI screen. Here, in a case where a natural feeling of camera shake needs to be reproduced as if the virtual viewpoint image is captured with a handheld camera, this is difficult to realize only with a joystick. As a method for realizing this, the use of a gyro sensor which senses a change in angle (angular velocity) of a rotation or tilt per time is considered.

It is a widespread practice to mount a gyro sensor on a controller, for example, in the field of video games. Japanese Patent Laid-Open No. 2011-239985 discloses a technique of using angular velocity information from a gyro sensor mounted on a controller to determine a character's operation of shaking an item (sword) in a video game, thereby making the orientation of the item substantially match the orientation of the controller.

### SUMMARY

A control apparatus according to the present disclosure is characterized by comprising: one or more memories storing instructions; and one or more processors executing the instructions to: obtain, for each frame, operation information designating a virtual camera in a virtual space via an operation member of an input device and angular velocity information from a gyro sensor comprised in the input device; determine, for each frame, an orientation of the virtual camera based on the operation information; and correct the orientation of the virtual camera determined for each frame based on the angular velocity information corresponding to a plurality of frames.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a configuration of a virtual viewpoint image generation system.

FIG. 2 is a diagram showing hardware resources of each apparatus forming the virtual viewpoint image generation system.

FIG. 3 is a flowchart showing a flow of an operation of generating and outputting virtual camera parameters based on operation information and angular velocity information according to a first embodiment.

FIGS. 4A and 4B are diagrams showing an example of a viewpoint input device.

FIG. 5 is a diagram illustrating that a position of a virtual camera can be uniquely specified based on a gaze point, a gaze point distance, and an orientation of the virtual camera.

FIG. 6 is a diagram illustrating a problem of a second embodiment.

FIG. 7 is a flowchart showing a flow of an operation of generating and outputting virtual camera parameters based on operation information and angular velocity information according to the second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In a case where an orientation of a virtual camera is determined based on an operation using a joystick and an angular velocity sensed by a gyro sensor, if an unintended behavior is given to a controller by another button operation or the like, the angular velocity changes with the behavior. In this case, in the above technique of Japanese Patent Laid-Open No. 2011-239985, it has been found as a result of the inventor's consideration that the virtual camera is oriented in an unintended direction and an object of interest goes out of the viewing angle, or a view direction is frequently changed, which makes a virtual viewpoint image difficult to see.

### First Embodiment

### System Configuration

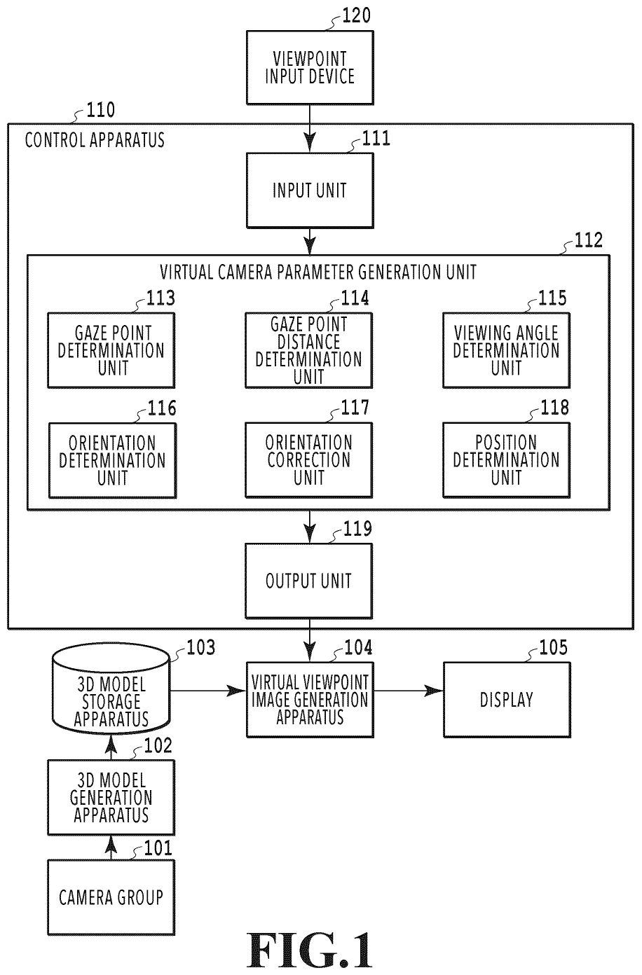

FIG. 1 is a diagram showing an example of a configuration of a system which generates a virtual viewpoint image according to the present embodiment. A virtual viewpoint image generation system of the present embodiment comprises a camera group 101, a 3D model generation apparatus 102, a 3D model storage apparatus 103, a virtual viewpoint image generation apparatus 104, a display 105, a control apparatus 110, and a viewpoint input device 120.

The camera group 101 formed by a plurality of imaging apparatuses (cameras) is arranged to surround an image capturing space in which an object is present and all the cameras perform image capturing in time synchronization with one another. In the present embodiment, it is assumed that each camera in the camera group 101 captures a moving image at a frame rate of 60 fps.

The 3D model generation apparatus 102 performs a foreground extraction process for each frame of the moving image obtained by each camera in the camera group 101 and generates an image (hereinafter referred to as “foreground silhouette”) indicating a silhouette of an object to be a foreground. Based on the generated silhouette image, a method such as Visual Hull is applied to generate data (generally referred to as “3D model”) indicating a three-dimensional shape of the object for each frame. A data format of the 3D model may be a polygon format, a point cloud format, a voxel format, or the like without any limitation. The 3D model storage apparatus 103 stores the 3D model generated by the 3D model generation apparatus 102.

The virtual viewpoint image generation apparatus 104 generates a virtual viewpoint image for each frame based on virtual camera parameters obtained from the control apparatus 110. The generated virtual viewpoint image is output to the display 105. However, the destination to which the virtual viewpoint image is output is not necessarily limited to the display and may be a streaming service or a broadcast station for instance. The display 105 displays the virtual viewpoint image received from the virtual viewpoint image generation apparatus 104.

The viewpoint input device 120 is an operation device for a user to designate a position or orientation of a virtual imaging apparatus (virtual camera) in a virtual space corresponding to the image capturing space of the camera group 101 and comprises a gyro sensor. The gyro sensor is an apparatus to sense an angular velocity per unit time. In the present embodiment, it is assumed that a 3-axis angular velocity about X, Y, and Z axes can be sensed. However, the 3-axis angular may be sensed by the combination of 1-axis gyro sensors or 2-axis gyro sensors. A user can continuously generate a virtual viewpoint image corresponding to a desirable virtual viewpoint by operating the viewpoint input device 120 while seeing the virtual viewpoint image displayed on the display 105 to designate a position and orientation of a new virtual camera. Incidentally, the viewpoint input device 120 only has to comprise a gyro sensor and an operation member such as a joystick or button to designate a gaze point, position, and orientation of a virtual camera according to a user operation. For example, the viewpoint input device 120 may be a gamepad of a type held in two hands as will be described later, or may be of a type held in one hand.

The control apparatus 110 generates a group of parameters (virtual camera parameters) specifying the position and orientation of the virtual camera based on the information input from the viewpoint input device 120 and outputs them to the virtual viewpoint image generation apparatus 104. It is assumed that at least information on the position, orientation, and viewing angle of the virtual camera in the virtual space is included in the virtual camera parameters in the present embodiment. The control apparatus 110 comprises an input unit 111, a virtual camera parameter generation unit 112, and an output unit 119. The virtual camera parameter generation unit 112 is formed by a gaze point determination unit 113, a gaze point distance determination unit 114, a viewing angle determination unit 115, an orientation determination unit 116, an orientation correction unit 117, and a position determination unit 118. Each unit of the control apparatus 110 will be described later in detail. It should be noted that the system configuration shown in FIG. 1 is just an example. For instance, the internal configuration of the virtual camera parameter generation unit 112 of the control apparatus 110 may be formed by a determination unit which calculates and determines various parameters of the virtual camera based on operation information and a correction unit which corrects the orientation of the virtual camera of the parameters determined by the determination unit.

### Hardware Configuration

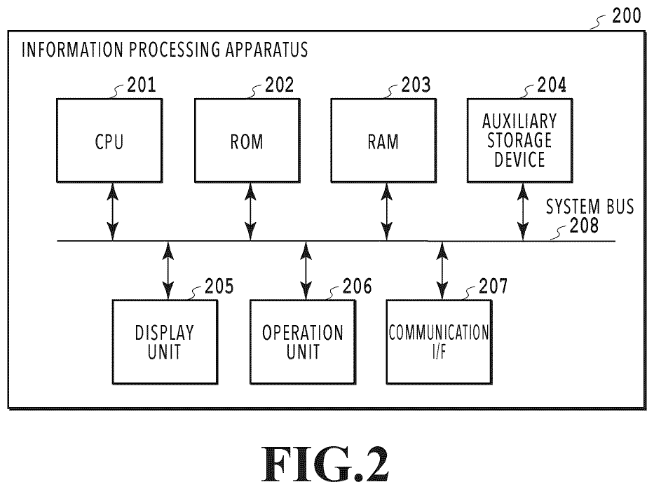

FIG. 2 is a diagram showing hardware resources of each apparatus forming the virtual viewpoint image generation system shown in FIG. 1. That is, the 3D model generation apparatus 102, the 3D model storage apparatus 103, the virtual viewpoint image generation apparatus 104, the control apparatus 110, and the viewpoint input device 120 can be implemented by an information processing apparatus 200 shown in FIG. 2.

The information processing apparatus 200 comprises a CPU 201, a ROM 202, a RAM 203, an auxiliary storage device 204, a display unit 205, an operation unit 206, a communication I/F 207, and a system bus 208.

The CPU 201 controls the whole of the information processing apparatus 200 using programs or data stored in the ROM 202 or the RAM 203. For example, each of the units 111 to 119 of the control apparatus 110 is implemented by the CPU 201 of the control apparatus 110 executing a predetermined program. However, the information processing apparatus 200 may comprise one or more pieces of dedicated hardware different from the CPU 201 such that at least part of processing executed by the CPU 201 is executed by the dedicated hardware. Examples of the dedicated hardware include an application-specific integrated circuit (ASIC), a field-programmable gate array (FPGA), and a digital signal processor (DSP).

The ROM 202 stores, for example, programs not requiring changing. The RAM 203 temporarily stores programs or data supplied from the auxiliary storage device 204, data externally supplied via the communication I/F 207, or the like. The auxiliary storage device 204 is formed by, for example, a hard disk drive and stores various kinds of data such as image data and sound data.

The display unit 205 is formed by, for example, a liquid crystal display or LED and displays a graphical user interface (GUI) or the like for a user to give an instruction to the information processing apparatus 200. The operation unit 206 is formed by, for example, a keyboard, mouse, joystick or touch panel and inputs various instructions to the CPU 201 in response to a user's operation. The CPU 201 operates as a display control unit which controls the display unit 205 and an operation control unit which controls the operation unit 206. It is assumed in the present embodiment that the display unit 205 and the operation unit 206 are present inside the information processing apparatus 200, but at least one of the display unit 205 and the operation unit 206 may be present as a separate apparatus outside the information processing apparatus 200.

The communication I/F 207 is used for communication between the information processing apparatus 200 and an external device. In a case where the information processing apparatus 200 has the function of wirelessly communicating with an external device, the communication I/F 207 comprises an antenna. The system bus 208 connects the units of the information processing apparatus 200 to one another to transfer information.

It should be noted that FIG. 2 shows an example of basic hardware comprised in common in each of the apparatuses forming the virtual viewpoint image generation system. The hardware configuration may differ according to the purpose or function of a target apparatus; for example, the control apparatus 110 may further comprise a gyro sensor.

### Operation Flow of Control Apparatus

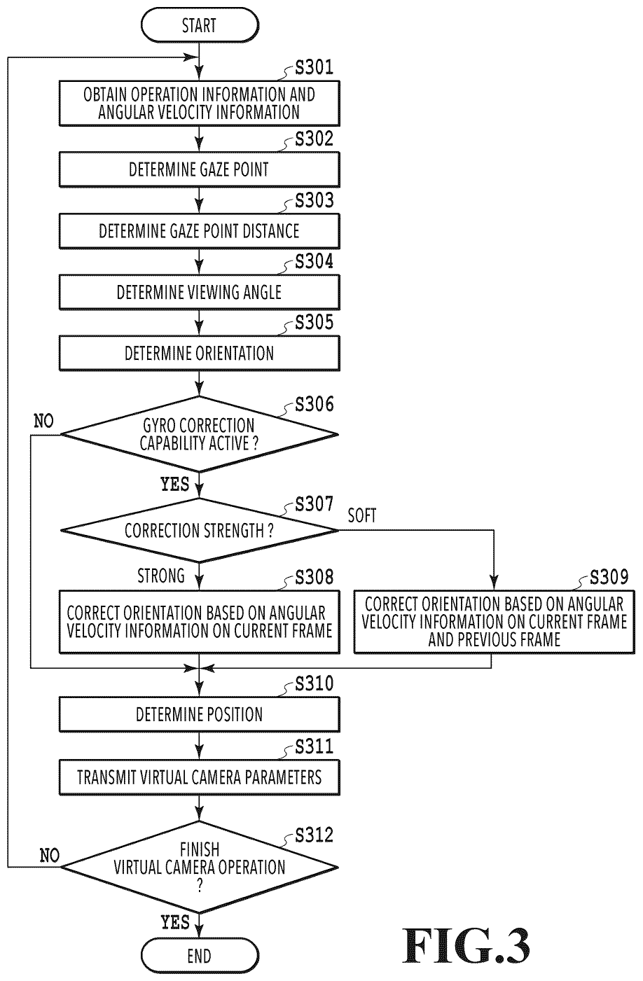

Next, the operation of the control apparatus 110 for generating and outputting virtual camera parameters based on the operation information and angular velocity information input from the viewpoint input device 120 is described in detail with reference to the aforementioned system configuration diagram shown in FIG. 1 and the flowchart shown in FIG. 3. In the following description, sign “S” denotes a step. In the present embodiment in which a virtual viewpoint image is generated based on a moving image captured at 60 fps, each process of S301 to S312 is executed for each frame per 1/60 of a second.

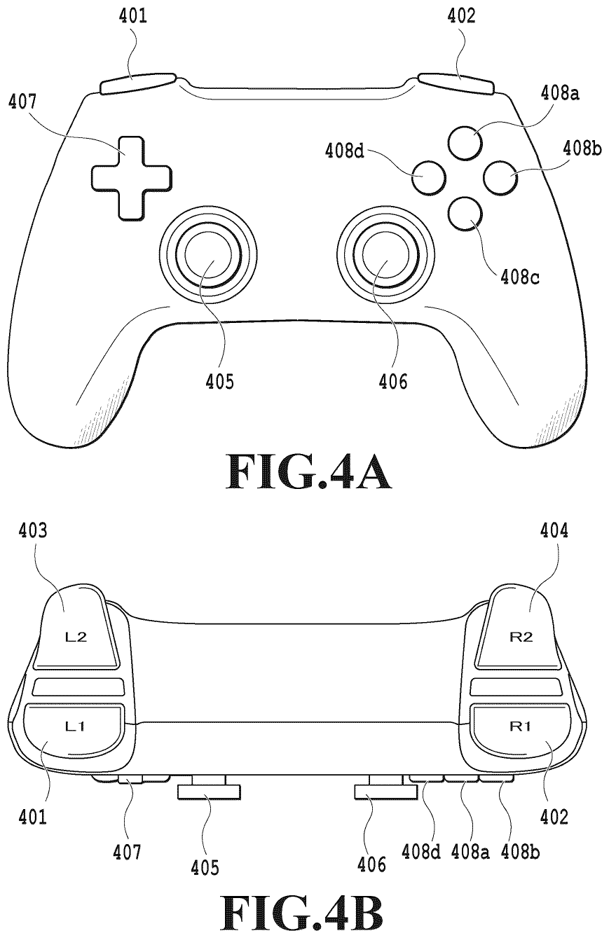

In S301, the input unit 111 obtains, via the communication I/F 207, operation information and angular velocity information about a current frame (a frame of interest as a target to be processed) which are output from the viewpoint input device 120. Here, the operation information is information indicating an operation content produced by, for example, a user tilting the joystick of the viewpoint input device 120. The angular velocity information is information indicating an angular velocity about three axes (pan, tilt, and roll axes) sensed by the gyro sensor mounted on the viewpoint input device 120. Here, a pan is an angle of rotation parallel to the ground surface, a tilt is an angle of rotation perpendicular to the ground surface, and a roll is an angle of rotation about an optical axis of the virtual camera. In the present embodiment, the angular velocity information is expressed by ωₚₐₙ, ω_{Tilt}, and ω_{Roll}, each of which is in a unit of [°/s]. FIGS. 4A and 4B show a gamepad held in two hands, which is an example of the viewpoint input device 120. The gamepad shown in FIGS. 4A and 4B comprises operation members such as L1/R1 buttons, L2/R2 buttons, a D-pad, left/right sticks, and face buttons. For example, a user tilts the left stick 405 in a desirable direction to transition a position of a point (gaze point) at which the virtual camera focuses in the virtual space in the X and Y axes. Further, a user presses down the L1 button 401 to raise the position of the gaze point in the Z axis and presses down the R1 button 402 to lower the position of the gaze point in the Z axis. Further, a user presses down the L2 button 403 to gradually reduce a distance (gaze point distance) between the virtual camera and the gaze point and presses down the R2 button 404 to gradually increase the gaze point distance. Further, a user presses down the upper part of the D-pad 407 to gradually reduce the viewing angle of the virtual camera and presses down the lower part to gradually increase the viewing angle of the virtual camera. Further, a user tilts the right stick 406 in a desirable direction to change the pan and tilt of the virtual camera. Further, of the four face buttons 408a to 408d, a user presses down the upper face button 408a to rotate the roll to the left and presses down the right face button 408b to rotate the roll to the right. The above is an example of the operation method of the virtual camera; the mapping of each button or the like is not limited to this. The obtained operation information and angle velocity information are sent to the virtual camera parameter generation unit 112. The virtual camera parameter generation unit 112 then uses each of the functional units 113 to 118 to execute each process of S302 to S310.

In S302, the gaze point determination unit 113 determines the gaze point of the virtual camera based on the operation information on the current frame obtained in S301. More specifically, the position of the gaze point in the current frame is obtained by calculating an amount of change from the gaze point in the previous frame based on the operation information on the current frame and adding the calculated amount of change to the position of the gaze point in the previous frame. It is assumed that the gaze point is always present on the optical axis of the virtual camera. In the present embodiment, the gaze point is expressed by three-dimensional coordinates in the three axes, the X, Y, and Z axes. The three-dimensional coordinates (X, Y, Z) are expressed by numerical values indicating distances from the origin, such as X=4.0, Y=9.0, and Z=1.5, each of which is in a unit of [m]. The origin (X, Y, Z)=(0, 0, 0) in this case is, for example, the center of the 3D model generation range. It is also assumed that in a case where the X axis is designated to be parallel to the ground surface, the Y axis is designated to be parallel to the ground surface and perpendicular to the X axis and the Z axis is designated to be perpendicular to the ground surface. Information on the determined gaze point is sent to the position determination unit 117.

In S303, the gaze point distance determination unit 114 determines a distance (hereinafter referred to as “gaze point distance”) between the virtual camera and the gaze point determined in S302. More specifically, the gaze point distance in the current frame is obtained by calculating an amount of change from the gaze point distance in the previous frame based on the operation information on the current frame and adding the calculated amount of change to the gaze point distance in the previous frame. In the present embodiment, the unit of the gaze point distance R is [m]. Information on the determined gaze point distance is sent to the position determination unit 117.

In S304, the viewing angle determination unit 115 determines an angle of view of the virtual camera based on the operation information on the current frame obtained in S301. More specifically, the viewing angle in the current frame is obtained by calculating an amount of change from the viewing angle in the previous frame based on the operation information on the current frame and adding the calculated amount of change to the viewing angle in the previous frame. Incidentally, there is such an interrelationship that the viewing angle increases with the decrease of the focal length and decreases (zooms in) with the increase of the focal length, and the viewing angle is uniquely determined by the focal length. Thus, in the present embodiment, the viewing angle is specified by a numerical value (zoom value) indicating the focal length such as a zoom value=6.0 (in a unit of [mm]). Information on the determined viewing angle (˜ focal length) is sent to the position determination unit 117.

In S305, the orientation determination unit 116 determines the orientation of the virtual camera based on the operation information obtained in S301. More specifically, the orientation in the current frame is obtained by calculating an amount of change from the orientation in the previous frame based on the operation information on the current frame and adding the calculated amount of change to the orientation in the previous frame. In the present embodiment, the orientation of the virtual camera is expressed by numerical values of the three angles of pan, tilt, and roll, such as (Pan, Tilt, Roll)=(20.0, 10.0, 2.0), each of which ranges from −180[°] to 180[°]. Information on the determined orientation is sent to the position determination unit 117.

In S306, the orientation correction unit 117 determines whether the function (hereinafter referred to as “gyro correction function”) of correcting the orientation of the virtual camera based on the angular velocity information from the gyro sensor is active. The process to be executed next branches according to the result of determination. Here, it is only required that the setting of activation or deactivation of the gyro correction function be selected in advance by a user via an unshown user interface screen (UI screen), for example. In a case where the gyro correction function is active, S307 is executed next. In a case where the gyro correction function is inactive, S310 is executed next.

In S307, the orientation correction unit 117 determines a setting value of a correction strength to execute the gyro correction function. The process to be executed next branches according to the result of determination. Here, it is only required that the setting of the correction strength be selected in advance by a user, for example, with such a screen configuration that the strength selection is allowed after “activation” is selected in the above UI screen. In the present embodiment, it is assumed that either “strong” or “soft” is set as the setting value of the correction strength. In a case where the setting value of the correction strength is “strong,” S308 is executed next. In a case where the setting value is “soft,” S309 is executed next.

In S308, the orientation correction unit 117 corrects the orientation of the virtual camera determined in S305 based on the angular velocity information on the current frame obtained in S301. In the present embodiment, the processing at the frame rate of 60 fps is assumed. In this case, the correction amount is calculated by dividing the input angular velocity in the current frame by 60. In the present embodiment, since the orientation of the virtual camera is specified by the pan, tilt, and roll, the correction amounts (dPan, dTilt, dRoll) are obtained by the following formulas (1) to (3).

$$dPan = \frac{{ω}_{Pan}}{fr} \qquad Formula ( 1 )$$

$$dTilt = \frac{{ω}_{Tilt}}{fr} \qquad Formula ( 2 )$$

$$dRoll = \frac{{ω}_{Roll}}{fr} \qquad Formula ( 3 )$$

In the above formulas (1) to (3), fr indicates the frame rate and its value is 60 in the present embodiment. For example, it is assumed here that the input angular velocity information is (ωₚₐₙ, ωₜᵢₗₜ, ωᵣₒₗₗ)=(20.0, 30.2, −12.0). In this case, the correction amounts (dPan, dTilt, dRoll)=(0.333, 0.503, −0.2) are obtained by the above formulas (1) to (3). The correction amounts (dPan, dTilt, dRoll) thus calculated are added to the orientation (Pan, Tilt, Roll) determined by the orientation determination unit 116 to obtain the corrected orientation in this step. That is, the corrected orientation (Pan_corr, Tilt_corr, Roll_corr) is expressed by the following formulas (4) to (6).

$$Pan\_corr = Pan + dPan \qquad Formula ( 4 )$$

$$Tilt\_corr = Tilt + dTilt \qquad Formula ( 5 )$$

$$Roll\_corr = Roll + dRoll \qquad Formula ( 6 )$$

In S309, the orientation correction unit 117 corrects the orientation of the virtual camera determined in S305 based on the angular velocity information on the current frame obtained in S301 and the angular velocity information on the immediately preceding frame. A too strong correction of the orientation based on the angular velocity information may conversely make the image difficult to see. In this case, a user selects “soft.” In this step, the correction amounts (dPan, dTilt, dRoll) are first obtained using the above formulas (1) to (3) for each of a plurality of frames including the current frame and the immediately preceding frame. After that, values (dPanₛₘ, dTiltₛₘ, dRollₛₘ) obtained by smoothing the correction amounts obtained for the respective frames are added to the orientation (Pan, Tilt, Roll) determined by the orientation determination unit 116. That is, the corrected orientation (Pan_corr, Tilt_corr, Roll_corr) in this step is expressed by the following formulas (7) to (9), in which fluctuations in the plurality of frames are smoothed.

$$Pan\_corr = Pan + {dPan}_{SM} \qquad Formula ( 7 )$$

$$Tilt\_corr = Tilt + {dTilt}_{SM} \qquad Formula ( 8 )$$

$$Roll\_corr = Roll + {dRoll}_{SM} \qquad Formula ( 9 )$$

Here, as a method of smoothing, for example, it is considered that average values are calculated and (dPanₐᵥₑ, dTiltₐᵥₑ, dRollₐᵥₑ) are adopted as the above correction amounts (dPanₛₘ, dTiltₛₘ, dRollₛₘ). However, it is only necessary to smooth fluctuations in the plurality of frames and the method is not limited to one using average values. For example, median values may be adopted instead of average values.

Regarding the angular velocity information on the plurality of frames including the previous frame, the number of frames to be considered is not limited. For example, a moderate feeling of camera shake can be reproduced by considering angular velocity information corresponding to four frames in total, the current frame and three immediately preceding frames. Further, it is only necessary to smooth fluctuations in the plurality of frames. For example, median values may be adopted instead of average values.

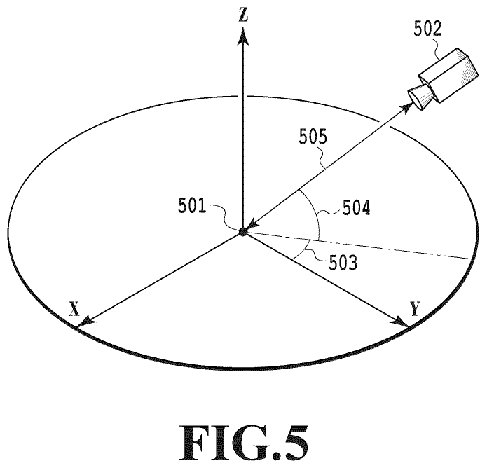

In S310, the position determination unit 118 determines the position of the virtual camera based on the gaze point, the gaze point distance, and the orientation of the virtual camera, which have been determined through the processes until now. In the present embodiment, the position of the virtual camera is expressed by three-dimensional coordinates of the three axes, the X, Y, and Z axes, like the gaze point. FIG. 5 is a diagram illustrating that the position of the virtual camera can be uniquely specified based on the gaze point, the gaze point distance, and the orientation of the virtual camera. In FIG. 5, black dot 501 indicates the gaze point and double-sided arrow 505 indicates the distance between the virtual camera 502 and the gaze point 501. It is understandable from FIG. 5 that the position of the virtual camera 502 is determined such that the virtual camera 502 faces the gaze point from the gaze point distance 505, angle 503 of the virtual camera 502 in the pan direction, and angle 504 of the virtual camera 502 in the tilt direction. Although the position of the gaze point 501 is the origin (0, 0, 0) in FIG. 5 for the sake of explanation, the position of the gaze point may be any position in the virtual space. The way to obtain the three-dimensional coordinates (Xcam, Ycam, Zcam) indicating the position of the virtual camera differs according to whether the gyro correction function is active or inactive. In a case where the gyro correction function is active, the three-dimensional coordinates can be obtained by the following formulas (10) to (12) using the orientation (Pan_corr, Tilt_corr, Roll_corr) corrected in S308 or SS309.

$$Xcam = R Cos ( Tilt\_corr \times \frac{π}{180} ) * ( - Sin ( Pan\_corr \times \frac{π}{180} ) ) + X \qquad Formula ( 10 )$$

$$Ycam = R Cos ( Tilt\_corr \times \frac{π}{180} ) * ( - Cos ( Pan\_corr \times \frac{π}{180} ) ) + Y \qquad Formula ( 11 )$$

$$Zcam = R ( - Sin ( Tilt\_corr \times \frac{π}{180} ) ) + Z \qquad Formula ( 12 )$$

In the above formulas (10) to (12), R indicates the gaze point distance determined in S303 and X, Y, and Z indicate the three-dimensional coordinates (X, Y, Z) of the gaze point determined in S302.

On the other hand, in a case where the gyro correction function is inactive, the three-dimensional coordinates (Xcam, Ycam, Zcam) indicating the position of the virtual camera are obtained by the following formulas (13) to (15) using the orientation (Pan, Tilt, Roll) determined in S305.

$$Xcam = R Cos ( Tilt \times \frac{π}{180} ) * ( - Sin ( Pan \times \frac{π}{180} ) ) + X \qquad Formula ( 13 )$$

$$Ycam = R Cos ( Tilt \times \frac{π}{180} ) * ( - Cos ( Pan \times \frac{π}{180} ) ) + Y \qquad Formula ( 14 )$$

$$Zcam = R ( - Sin ( Tilt \times \frac{π}{180} ) ) + Z \qquad Formula ( 15 )$$

In this manner, the virtual camera parameters are generated for each frame by the action of each unit of the virtual camera parameter generation unit 112.

In S311, the output unit 119 transmits the virtual camera parameters of the current frame generated by the virtual camera parameter generation unit 112 to the virtual viewpoint image generation apparatus 104 via the communication I/F 207.

In S312, whether to continue generating the virtual camera parameters is determined. For example, in a case where the operation information and the angular velocity information are being continuously input from the viewpoint input device 120 and the generation of the virtual camera parameters is continued, the process returns to S301 for continuation. In contrast, the input of the operation information and the angular velocity information from the viewpoint input device 120 is stopped and the generation of the virtual camera parameters is finished, the process exits this flow.

This is the end of the content of the virtual camera parameter generation process according to the present embodiment. Incidentally, the setting values of the correction strength are the two levels “strong” and “soft” in the present embodiment, but are not limited to this. For example, the correction strength may be selected among three or more levels such as “strong,” “normal,” and “soft.” Alternatively, a user may be only allowed to activate or deactivate the gyro correction function and the correction strength may be fixed at a recommended setting value (e.g., “soft”).

As described above, according to the present embodiment, the orientation of the virtual camera determined based on the operation information from the operation members of the viewpoint input device is corrected based on the angular velocity information from the gyro sensor mounted on the viewpoint input device, thereby enabling the reproduction of a natural feeling of camera shake in the virtual viewpoint image.

Incidentally, in the above embodiment, the setting values of the correction strength are expressed by the two levels “strong” and “soft,” which are equivalent to the activation and deactivation of the function of adjusting the correction amount. In the above embodiment, the smoothing process is not executed in a case where the setting value of the correction strength is “strong” and is executed in a case where the setting value of the correction strength is “soft.” Thus, it can be said that the activation or deactivation of the smoothing process is set.

### Second Embodiment

In the first embodiment, the orientation of the virtual camera determined based on the operation information from the operation members is corrected based on the angular velocity information from the gyro sensor. In the method of the first embodiment, however, the amount of change in position (amount of movement) of the virtual camera increases with the increase of the gaze point distance in a case where the orientation is corrected. This may cause an adverse effect such as a tendency to so-called motion sickness. Accordingly, an aspect of preventing an excessive increase of the amount of movement of the virtual camera in a case where the orientation of the virtual camera is corrected based on the angular velocity information from the gyro sensor is described as the second embodiment. It should be noted that the contents common to the first and second embodiments such as the system configuration are not described and differences are mainly described below.

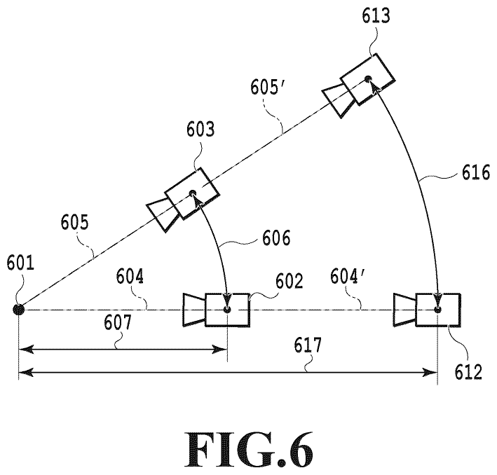

Prior to the description of the present embodiment, the problem of the present embodiment is explained with reference to FIG. 6. In FIG. 6, black dot 601 indicates a gaze point, double-sided arrow 607 indicates a gaze point distance of a camera 602, and double-sided arrow 617 indicates a gaze point distance of a camera 612. The cameras 602 and 612 indicate virtual cameras before orientation correction and cameras 603 and 613 indicate virtual cameras after orientation correction. Further, dash-dotted line 604 extending from the camera 602 to the gaze point 601 indicates an optical axis of the virtual camera 602 and dash-dotted line 604′ extending from the camera 612 to the gaze point 601 indicates an optical axis of the virtual camera 612. Further, dash-dotted line 605 extending from the camera 603 to the gaze point 601 indicates an optical axis of the virtual camera 603 and dash-dotted line 605′ extending from the camera 613 to the gaze point 601 indicates an optical axis of the virtual camera 613. Straight double-sided arrow 607 indicates a gaze point distance of the virtual cameras 602 and 603 and straight double-sided arrow 617 indicates a gaze point distance of the virtual cameras 612 and 613. Further, arch double-sided arrow 606 indicates a distance of movement from the virtual camera 602 before correction to the virtual camera 603 after correction and arch double-sided arrow 616 indicates a distance of movement from the virtual camera 612 before correction to the virtual camera 613 after correction. It can be seen in FIG. 6 that the distance of movement increases proportionately with the gaze point distance. Accordingly, even in a case where the input values of the angular velocity information (ωₚₐₙ, ωₜᵢₗₜ, ωᵣₒₗₗ) from the gyro sensor are the same, a large gaze point distance may cause a remarkable change in position of the virtual camera against a user's expectation. The present embodiment aims to control the correction amounts to prevent an excessive change in position of the virtual camera in a case where the orientation of the virtual camera is corrected.

### Operation Flow of Control Apparatus

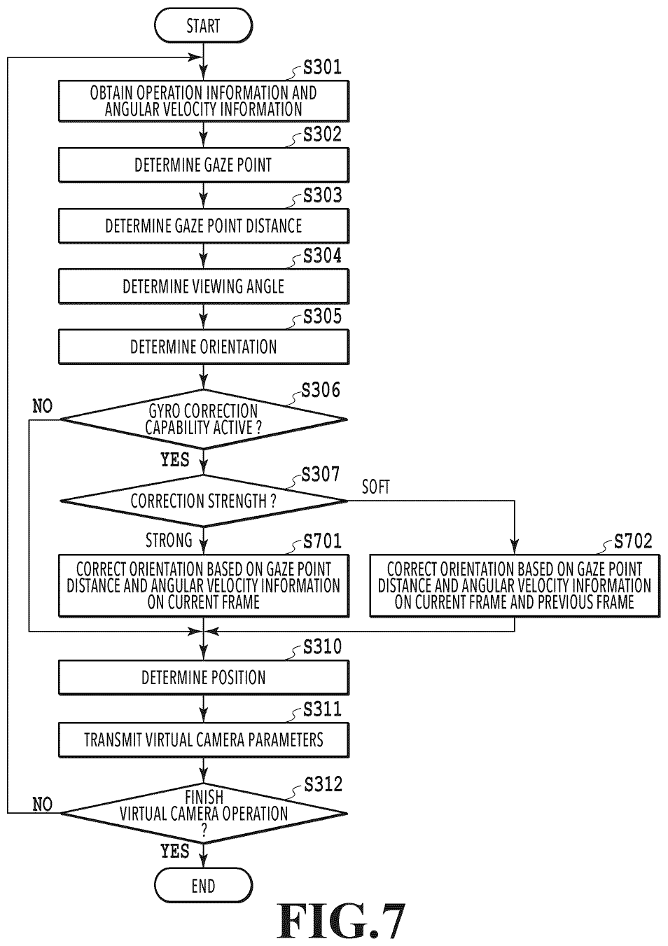

Next, the operation of the control apparatus 110 for generating and outputting the virtual camera parameters based on the operation information and angular velocity information input from the viewpoint input device 120 according to the present embodiment is described in detail. In the following description, sign “S” denotes a step. Like the flow of FIG. 3 of the first embodiment, it is assumed that the procedure shown in the flow of FIG. 7 is executed for each frame per 1/60 of a second.

S301 to S307 are the same as those in the first embodiment and are therefore not described here. In a case where the setting value of the correction strength is determined to be “strong” in S307, S801 is executed next. In a case where the setting value is “soft,” S802 is executed next.

In S701, the orientation correction unit 117 corrects the orientation of the virtual camera determined in S305 based on the angular velocity information on the current frame obtained in S301 and the gaze point distance determined in S303. Also in the present embodiment, the processing at the frame rate of 60 fps is assumed. In this case, the correction amount is calculated by dividing the input angular velocity in the current frame by 60. In addition, in the present embodiment, the calculation is made such that the correction amount decrease with the increase of the gaze point distance. More specifically, the correction amounts (dPan, dTilt, dRoll) are obtained by the following formulas (16) to (18).

$$dPan = \frac{{ω}_{Pan}}{fr} \times \frac{1}{CR + 1} \qquad Formula ( 16 )$$

$$dTilt = \frac{{ω}_{Tilt}}{fr} \times \frac{1}{CR + 1} \qquad Formula ( 17 )$$

$$dRoll = \frac{{ω}_{Roll}}{fr} \times \frac{1}{CR + 1} \qquad Formula ( 18 )$$

In the above formulas (16) to (18), fr indicates the frame rate, R indicates the gaze point distance determined in S303, and C is a constant having a value in a range of 0<1 for adjusting a reduction in correction amount according to the value of R. It is assumed here that the gaze point distance R=9 [m] and the angular velocity information (ωₚₐₙ, ωₜᵢₗₜ, ωᵣₒₗₗ)=(20.0, 30.2, −12.0). In this case, the correction amounts (dPan, dTilt, dRoll)=(0.033, 0.05, −0.02) are obtained by the above formulas (16) to (18). The correction amounts are about 1/10 of the correction amounts (dPan, dTilt, dRoll)=(0.333, 0.503, −0.2) calculated based on the same angular velocity information by the method of the first embodiment described above (see the description of S308). The correction amounts (dPan, dTilt, dRoll) thus calculated are added to the orientation (Pan, Tilt, Roll) determined by the orientation determination unit 116 to obtain the corrected orientation (Pan_corr, Tilt_corr, Roll_corr).

In S702, the orientation correction unit 117 corrects the orientation of the virtual camera determined in S305 based on the angular velocity information on the current frame and the immediately preceding frame and the gaze point distance determined in S303. More specifically, the correction amounts (dPan, dTilt, dRoll) are first calculated using the above formulas (16) to (18) for each of a plurality of frames including the current frame. Next, the average values (dPanₐᵥₑ, dTiltₐᵥₑ, dRollₐᵥₑ) of the calculated correction amounts are obtained. After that, the obtained average values are added to the orientation (Pan, Tilt, Roll) determined by the orientation determination unit 116 to obtain the corrected orientation (Pan_corr, Tilt_corr, Roll_corr). Like S309 of the first embodiment, the number of previous frames to be considered for the angular velocity information is not limited.

Subsequent S310 and S311 are the same as those in the first embodiment and are therefore not described here. This is the end of the content of the control process of the virtual camera according to the present embodiment. It should be noted that the above formulas (16) to (18) to calculate the correction amounts are just an example and may be any calculation formulas as long as the correction amounts decrease with the increase of the gaze point distance. For example, the exponential function may be used as shown in the following formulas (19) to (21).

$$dPan = {ω}_{Pan} / 60 \times 0.5 \hat{} R \qquad Formula ( 19 )$$

$$dTilt = {ω}_{Tilt} / 60 \times 0.5 \hat{} R \qquad Formula ( 20 )$$

$$dRoll = {ω}_{Roll} / 60 \times 0.5 \hat{} R \qquad Formula ( 21 )$$

As described above, according to the present embodiment, the correction amount of the orientation of the virtual camera is controlled according to the gaze point distance. This can prevent an excessive increase in amount of movement of the position of the virtual camera in a case where the orientation of the virtual camera is corrected based on the angular velocity information from the gyro sensor.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, a feeling of camera shake pleasant to a viewer can be realized in a virtual viewpoint image.

What is claimed is:

1. A control apparatus comprising:
one or more memories storing instructions; and
one or more processors executing the instructions to:
obtain operation information designating a virtual camera in a virtual space via an operation member of an input device and angular velocity information from a gyro sensor comprised in the input device;
determine an orientation of the virtual camera based on the operation information; and
correct the determined orientation of the virtual camera based on the angular velocity information,
wherein the correction is made such that a correction amount in a case where a distance between the virtual camera and a gaze point of the virtual camera is a second distance greater than a first distance is less than a correction amount in a case where the distance between the virtual camera and the gaze point of the virtual camera is the first distance.

2. The control apparatus according to claim 1, wherein
the one or more processors execute the instructions to:
determine, for each frame, a gaze point of the virtual camera based on the operation information.

3. The control apparatus according to claim 2, wherein
the orientation of the virtual camera determined for each frame is corrected such that the gaze point determined for each frame is not changed.

4. The control apparatus according to claim 1, wherein
the angular velocity information corresponding to a plurality of frames is angular velocity information corresponding to four frames in total, which are a current frame to be processed and three immediately preceding frames.

5. The control apparatus according to claim 2, wherein
the one or more processors execute the instructions to:
calculate a position of the virtual camera based on the determined gaze point, a distance to the determined gaze point, and the corrected orientation of the virtual camera.

6. The control apparatus according to claim 1, wherein
the one or more processors execute the instructions to:
output a virtual camera parameter for generating a virtual viewpoint image based on a plurality of captured images, the virtual camera parameter including at least information on a position of the virtual camera, an orientation of the virtual camera, and a viewing angle of the virtual camera.

7. The control apparatus according to claim 6, wherein
the virtual space corresponds to an image capturing space in which a plurality of imaging apparatuses perform image capturing in synchronization with one another, and
the virtual camera parameter is used to generate a virtual viewpoint image based on a plurality of captured images obtained through the image capturing by the plurality of imaging apparatuses.

8. The control apparatus according to claim 1, wherein
the one or more processors execute the instructions to:
determine a gaze point of the virtual camera based on the operation information.

9. A control method of a virtual camera, comprising the steps of:
obtaining operation information designating the virtual camera in a virtual space via an operation member of an input device and angular velocity information from a gyro sensor comprised in the input device;
determining an orientation of the virtual camera based on the operation information; and
correcting the determined orientation of the virtual camera based on the angular velocity information,
wherein the correction is made such that a correction amount in a case where a distance between the virtual camera and a gaze point of the virtual camera is a second distance greater than a first distance is less than a correction amount in a case where the distance between the virtual camera and the gaze point of the virtual camera is the first distance.

10. A non-transitory computer readable storage medium storing a program for causing a computer to perform a control method of a virtual camera, comprising the steps of:
obtaining operation information designating the virtual camera in a virtual space via an operation member of an input device and angular velocity information from a gyro sensor comprised in the input device;
determining an orientation of the virtual camera based on the operation information; and
correcting the determined orientation of the virtual camera based on the angular velocity information,
wherein the correction is made such that a correction amount in a case where a distance between the virtual camera and a gaze point of the virtual camera is a second distance greater than a first distance is less than a correction amount in a case where the distance between the virtual camera and the gaze point of the virtual camera is the first distance.
